(19) United States
(12) Patent Application Publication
(10) Pub. No.: US 2008/0320008 A1
(43) Pub. Date: Dec. 25, 2008

(54) Video Recording Device

(76) Inventors: Lee Cheng Yu, Singapore (SG); Kwong Heng Kwok, Singapore (SG); Yee Boon Goh, Singapore (SG)

Correspondence Address: Joseph J. Laks;Thomson Licensing LLC, 2 Independence Way, Patent Operations, PO Box 5312, PRINCETON, NJ, 08543, US

(21) Appl. No.: 11/629,272

(22) PCT Filed: Jun. 15, 2004
(86) PCT No.: PCT/EP04/06391

§ 371 Date: Feb. 5, 2008

(51) Int. Cl. G06F 7/00; G06F 17/30

(52) U.S. Cl. 707/100; 707/E17.009

(57) ABSTRACT

The invention refers to a method for updating of content information related to an audio/visual storage medium wherein content information is being stored on the storage medium after generating the content information. The updated content information is stored in a user data area of the data stream stored on the storage medium.

The invention refers to a video recording device, especially to a disk recording device like hard disk recorder or optical disk recorder.

From EP-A-0 424 653 there is known a video recorder that is provided for storing content information on a storage medium after generating the content information.

It is an object of the invention to propose an improved video recorder being provided for storing content information on a storage medium.

According to the invention content information related to an audio/visual storage medium, especially updated content information, is stored in a user data area of the data stream stored on the storage medium. This has the advantage that the content information is stored at a defined location, and that it is easily detectable as it goes with the data stream. It is further easy to update provided that the storage medium is a re-writeable storage medium. In case of an MPEG encoded signal a certain group or packet or any other suitable partition is changed therefor and recorded again. The inventive method has the further advantage that it does not influence other legacy devices or processes that do not apply said method as user data area is a reserved area not prescribed by a standard. An example for an audio/visual storage medium used with the invention is a DVD-Video disk or a so-called VCD, both being provided for storing audio as well as video data. An example for a storage medium being provided for audio storage is a conventional CD or a DVD-Audio.

The user data area of the data stream according to the invention is user data area of management information data stream, or of audio/video data stream, or of auxiliary data stream. Also a combination thereof lies within the scope of the invention. Advantage of placing the content information in user data area of management information data stream is that this is a defined place that refers to the complete storage medium and/or contains defined storage medium data management information. Advantage of placing the content information in user data area of the audio/video data stream is that the content information is thus directly linked to the data area it refers to. In this case it is, for example, automatically included in a copy action, even when such copy action is performed by a device or by a process that is not especially provided for handling such type of content information. Advantage of placing the content information in user data area of an auxiliary data stream is that such auxiliary data stream is in general less frequently appearing on a storage medium than audio/video data but more frequently than management information data, so that it provides advantages of both these solutions while being provided only at an intermediate number of locations compared to these solutions.

Preferably the content information stored in the user data area of the data stream is related to the respective data stream partition, or is related to the respective storage medium, or is related to a plurality of storage media. Advantage of the user data area being related to the respective data stream partition is that this solution allows for very selective information related to the special position. Such special partition is for example a group of pictures, a sequence, a packet, a whole title, a certain time or data amount equivalent or the like. Sequence, group of pictures etc. are defined in MPEG standards, however, similar partitions also are present in non MPEG data. Content information being related to the specific storage medium has the advantage that it allows for a quick overview of the whole content of the storage medium. Content information being related to a plurality of storage media has the advantage that it allows for a complete overview of a certain user's collection of storage media, e.g. his or her collection of DVD disks.

According to the invention content information stored on the storage medium and content information present in a reading and/or recording device are compared to each other every time the storage medium is inserted to and/or removed from the reading and/or recording device. In case the respective information differ from each other an update of the respective outdated information is performed, where possible. No possibility for update is given in case that the recording medium does not allow for overwriting or does not provide the possibility for updates. An advantage of the updating scheme according to the invention is that there is always the latest content information present in the device that is using the storage medium. In case that content information has been changed on the device, the most recent information is also made available on the storage medium. Thus, using the inventive updating scheme, a backup exists for either the content information memory of the device or the content information stored on the recording medium being deleted or disturbed accidentally. In case the device is a read only device, or in case the storage medium is write protected, or in case no sufficient time is left for updating, or under similar circumstances, the updating step is skipped.

Preferably the content information contains genre information, and/or storage medium name, and/or title name, and/or related data name. This has the advantage that updating is performed for the content information deemed to be most important to the user and/or most likely to be changed by the user.

A device according to the invention is provided for carrying out the method according to the invention.

A storage medium according to the invention contains content information being stored in a user data area of the data stream recorded on the storage medium. It is physically different from general storage media in that it contains a data stream having a user data area in which data is present. This data namely is content information related to the content of the storage medium or even related to the content of other storage media.

Further advantages can be taken from the description of preferred embodiments. Of course, different combinations of features than those described are also in the scope of the invention. The figures show:

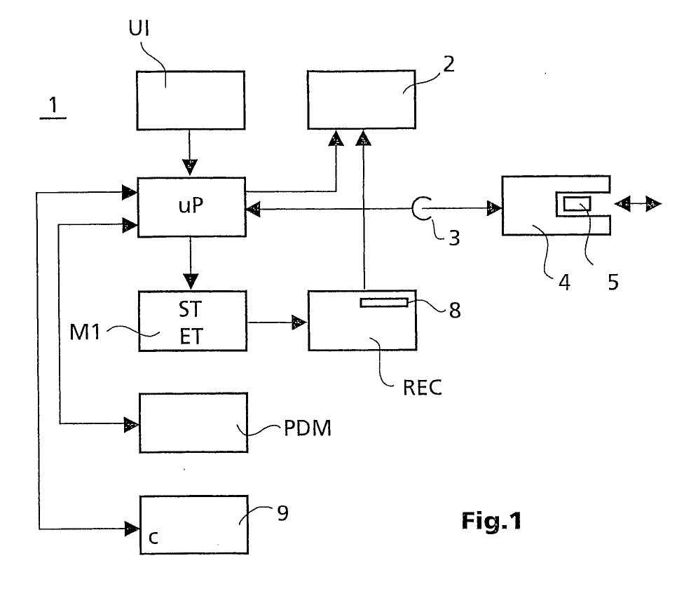

FIG. 1 schematics of an inventive device,

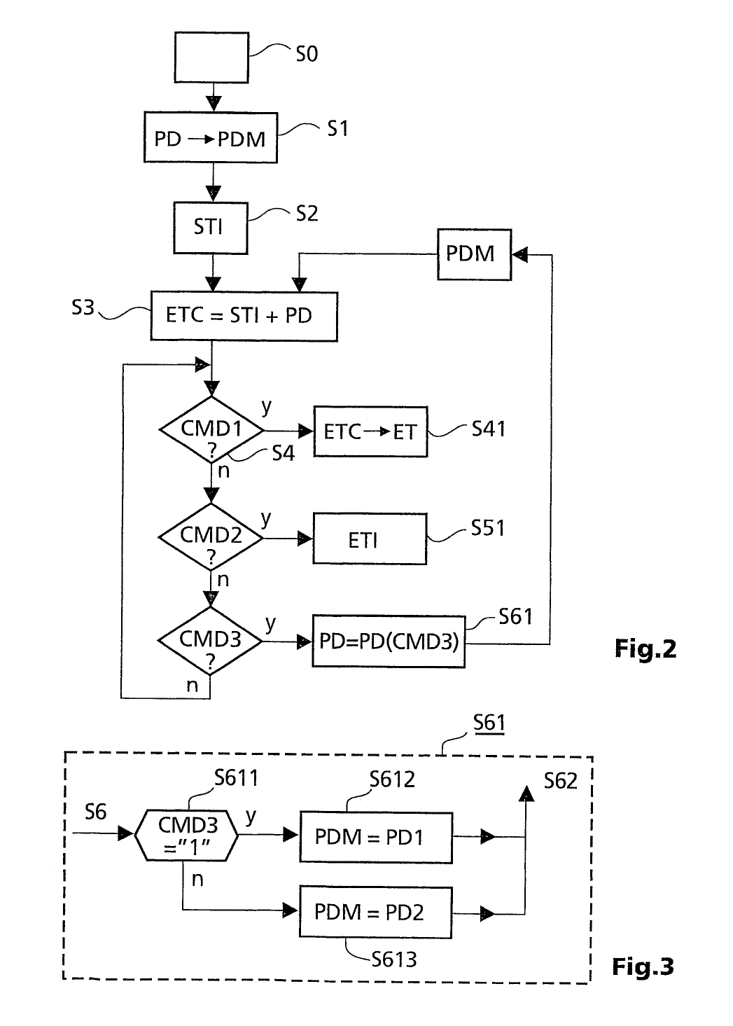

FIG. 2 timer programming method,

FIG. 3 detail of the timer programming method,

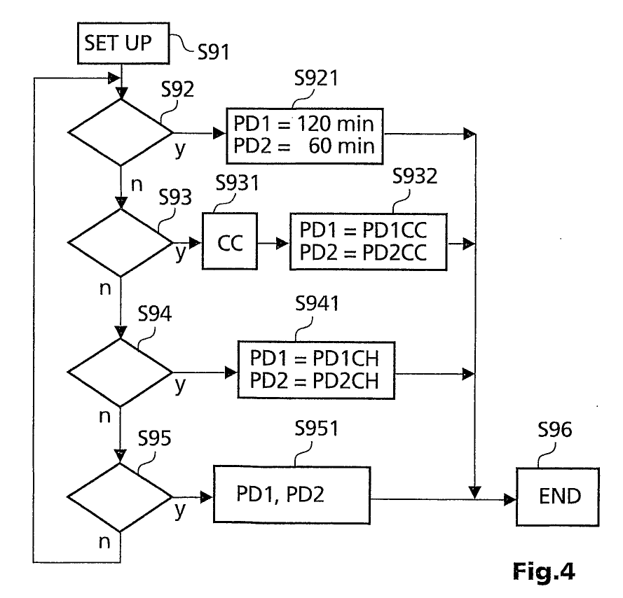

FIG. 4 set-up recording timer programming,

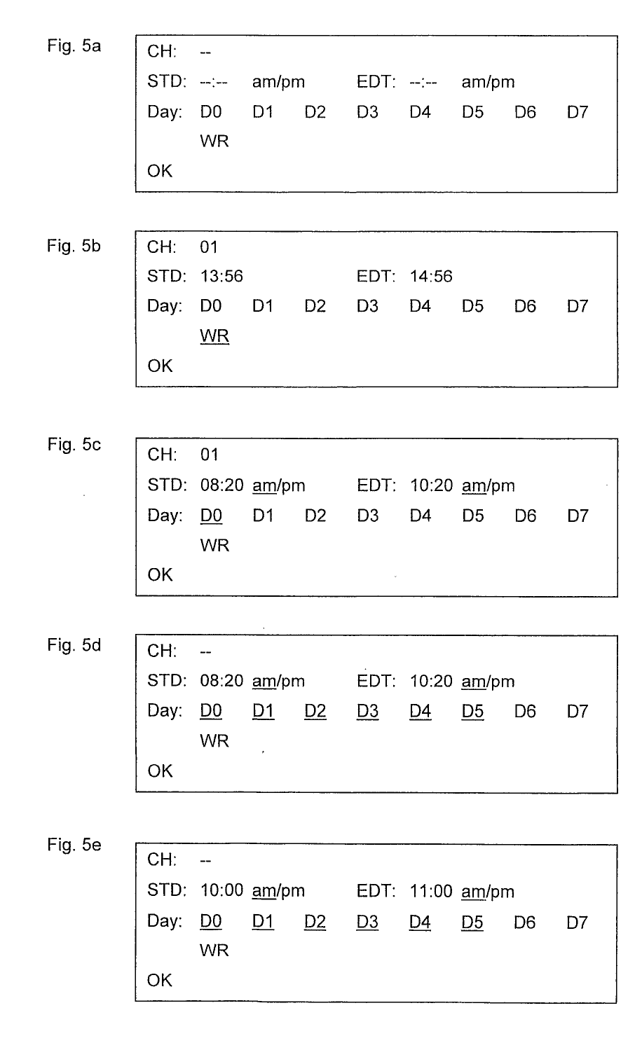

FIG. 5a-5e different displays during timer programming,

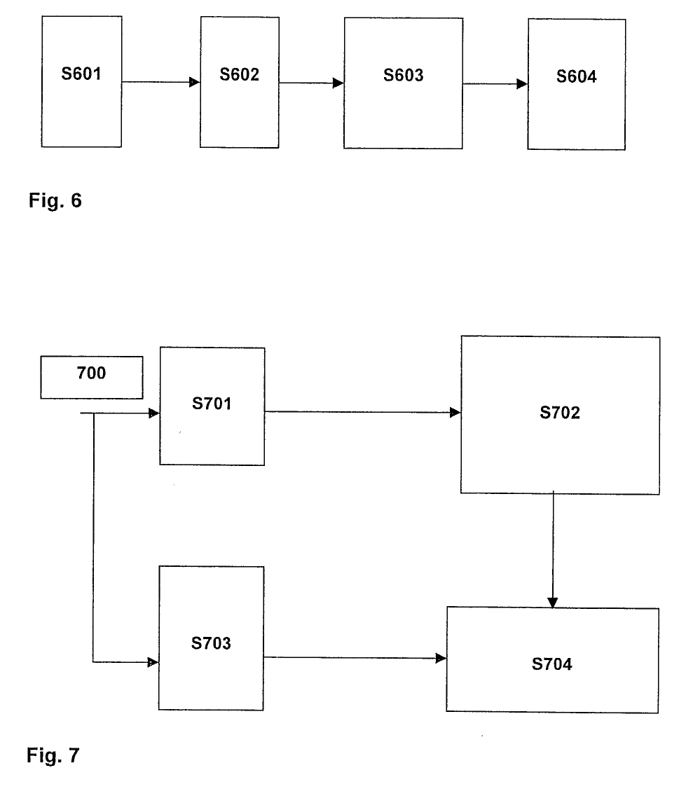

FIG. 6 creation of a DiscLibrary linked list

FIG. 7 adding to and deleting from a memory,

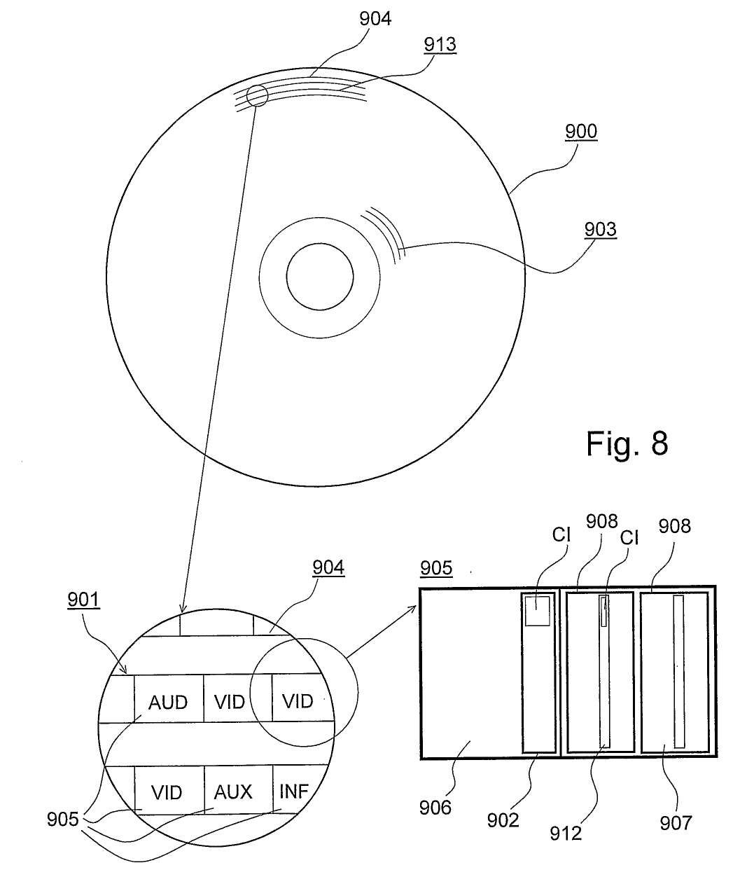

FIG. 8 arrangement of disk library on a disk.

FIG. 1 shows a schematic view of an inventive video recording device 1. A recording and playback section REC outputs a playback signal to a display 2. The display 2 is also provided for displaying a timer menu as provided by a microprocessor uP. The microprocessor uP receives commands from a user interface UI and transfers start time ST and end time ET to a memory M1. In dependency on the times ST, ET set in memory M1 the recording and playback section REC starts and ends recording if timer mode is selected. The microprocessor is also connected to a predetermined duration memory PDM for receiving a predetermined duration PD and for calculating an end time ETC therefrom and from an input start time STI. A disk as recording medium 8 is shown inserted into recording and playback section REC. It may be a removable disk as DVD or a hard disk. The device 1 is also provided with a further memory 9. The device 1 has also a link 3 through which an external removable media device 4 for removable media 5 is connectable to and disconnectable from the device 1.

FIG. 2 shows an example of a timer programming method. After the start in step SO a standard predetermined duration PD is set in a predetermined duration memory PDM in step S1. In step S2 an input start time STI is received. In step S3 a calculated end time ETC is computed as ETC=STI+PD. In step S4 it is checked whether an end type command CMD1 is received. In this case the calculated end time ETC is taken as end time ET in step S41 and the timer programming is ended. Otherwise, it is checked in step S5 whether a second type command CMD2 is received. If such command is received, in step S51 the timer programming is continued without further calculating an end time ETC. When the timer program is finished after step S51, the end time ET is taken as an input end time ETI or, if such is not present, the last calculated end time ETC is taken. If the condition of step S5 is not fulfilled, it is checked in step S6 whether a third type command CMD3 is received. If this is the case, the predetermined time PD is updated in step S61 in accordance with the command CMD3 and entered in step S62 in the predetermined duration memory PDM. If the result of step S6 is negative, i.e. if no command or a command irrelevant for the selection is received, it is returned to step S4. Preferably, a function to leave the routine after a certain time without command is implemented but not shown here.

FIG. 3 shows a detail of the timer programming method regarding the updating step S61. In step S611 it is checked whether the third type command indicates a single event recording. If this is the case, the predetermined duration memory PDM is updated with a first predetermined duration value PD1 in step S612. If in step S611 a repeated event recording is detected, the predetermined duration memory PDM is updated in step S613 with a different duration, the second predetermined duration PD2.

FIG. 4 shows a set-up procedure regarding timer programming. After set-up is started in step S91 the user's request is detected. In step S92 it is checked whether standard conditions are requested. In this case the first predetermined duration PD1 is set to 120 minutes and the second predetermined duration PD2 is set to 60 minutes in step S921. If in step S93 it is detected that country dependent determination is selected, the country information is determined in step S931. This might be by direct user input or by checking an already existing country information. Following, in step S932 first and second predetermined duration PD1, PD2 are set to country dependent values PD1CC, PD2CC. Preferably, a table indicating appropriate values for each country CC is available. In step S94 it is checked whether channel dependent determination is selected. In this case predetermined durations PD1 and PD2 are set to channel dependent values PD1CH, PD2CH in step S941. The latter are preferably taken from a respective table. In step S95 it is checked whether the user wants to determine the durations himself and the predetermined durations PD1, PD2 are received in step S951 from the user. In step S96 the predetermined durations PD1, PD2 are stored to the predetermined duration memory PDM.

FIGS. 5a to 5e show different displays during timer programming. The selected channel is indicated by CH, start time and end time are displayed as STD and ETD, the day of the timer programming is indicated by D0 to D7, wherein D0 is today, D1 is the following day, D2 the second following day and so on. A weekly repeat is indicated by WR. A confirmation command is indicated by an ok button OK. For countries where the am/pm time standard is used, such indications are given. A timer recording that shall be repeated from the next day until the 4^{th} next day, the day indicators D1, D2, D3 D4 are to be selected by the user.

It is now described to increase the stop time automatically to be some fixed duration later than the start time when setting up a timer. Usually it occurs the problem that when the user is setting up a new timer or is modifying an existing timer in Timer Setup Screen, all possible entries CH, STD, ETD must be entered, otherwise an error message will appear. According to the described embodiment by default the stop time ETD is set to one hour later than the start time STD with the input start time STI being the start time. If no start time STI is input, the current time is taken as start time STI. With this new proposal, the user is provided with a more convenient way to setup a timer with the duration PD the same as the fixed one by entering the start time only, such as 1 hour. It works this way: when user has entered the start time completely, i.e. all four digits of STD the end time ETD is updated automatically by advancing it one hour from the start time, since most of the time the user would setup timers with one hour duration. So user need not to enter an end time ETI if that is the record duration he wants. He can also change the end time ETD by entering another four digits.

The duration is pre-set in the system, of course it will be set to values other than the one hour if it is more desirable, e.g. based on some program duration statistics. The regular programs as drama or variety show are commonly one hour or half an hour long at least in US and Singapore.

When a new timer is set up, the Timer Setup Screen, as shown in FIG. 5b, is perforated with default values. The current channel, here channel 01 is used, the Current System Time, e.g. 13:56, is used for the default Start Time STD, and Current Time plus one hour as the default Stop Time ETD, here 14:56. And with the method according to the invention the device provides some additional functions, which bring some convenience while setting up new timers. It is about to set the End Time ETC a pre-fixed amount of time the predetermined duration PD later than the actual Start Time STD automatically after the user completes the four digits entry of Start Time STI, so that the user needs not set the End Time ET if the automatically set End Time ETC suits his needs. Of course it is still possible to set a preferred end time, ET, thus overriding the calculated end time. Dependent on the timer frequency, the pre-fixed amount of time PD is 120 minutes for ONCE timers, as this event is most likely to be a movie, and 60 minutes for timers with other frequencies, as this duration is suitable for sitcoms, variety shows and the like. In order not to be too smart, this is only applicable to the new timers, not to the modified timers. Further, normally the End Time is set automatically only once. That means as long as the user does not navigate from STD to other buttons, but only highlights on Start Time Button STD and enters complete Start Time STI repeatedly or toggles the am/pm repeatedly, if available, the End Time ETD would update automatically according to the Start Time STD and the Frequency.

Here are some examples for the application of the timer setting method as described above. FIG. 5c-e show a first example:

By default, the Frequency is ONCE, i.e. single event recording. Hence when the user opens up a new timer, the default End Time ETD would be PD=120 minutes later than the Start Time STD. Here, the current time is 08:20, thus STD=08:20 and ETD=10:20. The channel is channel 01. Now the user moves down to the Day Button, and changes the Frequency from D0 (single day) to D0-D5 i.e. Mon-Fri if the current day is Monday, see FIG. 5d. No change on Start time STD or Stop time ETD is done at this stage. Now the user enters 10:00 as Start Time, and the Stop Time updates to 11:00 automatically, as PD2=60 minutes is used for repeated event, see FIG. 5e. Without leaving the Start Time Button, the user now toggles am to pm, the Stop Time updates to 11:00 pm also (not shown), as the start time field has not been left. Further, without leaving the Start Time Button, the user changes the Start Time to 02:00 am, and the stop time automatically updates to 03:00 am (not shown).

If now the user navigates away from the Start Time Button, maybe to change the frequency and comes back to set the Start Time STD, or goes to the Stop Time ETD and changes the Stop Time ETD and comes back to set the Start Time STD. Under both conditions, the end time ETD is not updated automatically again as the described navigation commands belong to a second type of commands that indicates that no further automatic update is desired. But user can enter their preferred ones.

FIG. 5c-e show a second example: By default, the Frequency is ONCE, i.e. single event recording. Hence when the user opens up a new timer, the default End Time ETD would be PD=120 minutes later than the Start Time STD. Here, the current time is 08:20, thus STD=08:20 and ETD=10:20. The channel is channel 01. Now the user moves down to the Day Button, and changes the Frequency from D0 (single day) to D0-D5 i.e. Mon-Fri, see FIG. 5d. No change on Start time STD or Stop time ETD is done at this stage. Now the user enters 10:00 as Start Time, and the Stop Time updates to 11:00 automatically, as PD2=60 minutes is used for repeated event, see FIG. 5e. Now the user navigates away from the Start Time Button, and if he comes back to the Start Time Button again, the End Time does not update automatically but stays as in FIG. 5e, as the navigation command is taken as an indication that no further update is desired.

The inventive device further comprises a disk library feature. A content index of each recording medium 8 is stored in a memory 9, also named EEPROM 9, in the following. The user may select from the content index stored in memory 9 a title to be played back. The microprocessor uP, therefore, takes data from memory 9 and displays a respective menu at display 2. From the displayed information the user knows which of several recording media 8, especially DVD disk or other removable storage media, to insert into the device 1 for playing back the desired title. An optimised storage of disk library information on EEPROM is proposed. The invention provides a flexible management of the EEPROM 9 for storing titles recorded on discs 8.

Instead of predefining the number of discs 8 and number of titles per disc 8 to be stored, it is suggested that the user just records in the EEPROM 9 consecutively all titles of a disc 8, same for the next disc 8, and so on, until the EEPROM 9 is full. This has the advantage to allow better flexibility for the user. Below is some explanation about this feature: Each disc 8 is assigned with a unique number. A Disc 8 with a unique number with one or several recordings will be assigned to a disc number. Every title recorded on a disc 8 is related or linked by the disc number. This information is stored in the EEPROM 9. There is a free EEPROM token list generated by the software, e.g. in the microprocessor uP. In case that e.g. the first title is deleted from the disk 8, that the respective EEPROM location will be free. Subsequent recordings will get the first available EEPROM location in the ‘free EEPROM token list’ and the respective information is stored into that location.

The flow chart of FIG. 6 shows the creation of DiscLibrary linked list. In step S601 a disc linked list is created. In the following step S602 a titles linked list is created. After this in step S603 a list of all available spaces in the memory 9, a so-called free EEPROM token linked list, is created. After this in step S604 requests for serving messages is awaited.

The flow chart of FIG. 7 shows how to add and delete a disc 8 or a title of a disk 8 to and from the EEPROM memory 9. Depending on the content of a message 700 received from user input or generated from another unit of the device it is proceeded to step S701 or S703, respectively. In step S701 the information about a disk 8 or the information about a title of a disk 8 is to be added to the memory 9. In order to do so in step S702 the first available location in memory 9 is looked up in the free EEPROM token linked list. The respective information is stored in the found location, and in step S704 the free EEPROM token linked list is updated to no longer include said location. In step S703 the information about a disk 8 or the information about a title of a disk 8 is to be deleted from the memory 9. This is performed and following the free EEPROM token linked list is updated accordingly in step S704 to include the respective memory location.

FIG. 8 shows a storage medium 900 in schematic view. Storage medium 900 is depicted as disk, e.g. digital video disk DVD, having different partitions 903, 913. Of these partitions 903, 913 some tracks 904 are depicted schematically.

In an enlarged view a part of track 904 is shown. Several parallel parts of track 904 which is arranged as spiral or concentric circles can be seen. The track contains a data stream 901 that contains different data element blocks 905. The different data element blocks 905 are indicated with AUD if they contain audio data, with VID if they contain video data, with AUX if they contain auxiliary data and with INF if they contain management information. An even more enlarged view shows one of data element blocks 905 consisting of a header area 906 and a payload area 907. Header area 906 contains header information (not shown) as well as a user data area 902. The user area 902 contains, amongst others, which are not depicted here, content information CI. In the payload area 907 payload blocks 908 are shown, which, themselves, also contain a user data area 912 in which content information CI may be contained. The content information CI may be one of content information CIP related to the data stream partition 903, 913 or content information CID related to the respective storage medium 1 or content information CIL related to plurality of storage media 1, e.g. related to a disk library.

For displaying the information for a certain disk 8, the EEPROM memory 9 is searched for all entries related to the specific disk number.

A disk library preferably comprises genre information, which is a rating as for example musical, theatrical etc.

Genre information relating to a recording on a certain disk 8 is kept in the EEPROM memory 9 of the playback/recording device 1. It is thus available for the certain device 1.

According to the invention information about genre is stored in the EEPROM memory 9 as well as in a specific user data area in the data stream on the disk 8. Thus the disk library is not dependent on the device 1. Each disk 8 contains the same library information as the device 1, as long as the information in memory 9 is not changed. As a rewritable disk 8 is used, it can also be updated.

This has the advantage that the user's disk library is available not only on a certain machine but on several disks 8. It thus does not get lost if this machine is replaced by another machine. In case the user makes use of several play back and/or recording devices 1, all of these get updated identical library information via exchange of disks 8.

Different than in XDS or MPEG, where such information is stored somewhere, according to the proposal it is stored at a defined place.

After recording is done, selected disc information is update to the system's disc library in memory 9. One of the information stored is genre. The user is able to set or to modify the genre setting through the user interface screen 2. In case the user changes the genre setting on another compatible recorder machine, to enable the system to have the latest genre setting, information about genre is stored in a specific user data area in the data stream on the disk 8. Thus the disk library is not dependent on the device 1. Each disk 8 contains the library information.

The specific user data area in the datastream on the disk is preferably a video recording manager information recording information user data field. Such fields are usually provided for in a standard for recordable media. An advantage of this selection is that such fields are provided for new definitions without violating the standard. Such field is also easily accessible as it is on a higher level than directly in the recorded datastream. Of course, also user data fields of the datastream itself are advantageously used for storing the genre information. In this case it is also accessible for devices not looking into the recording specific data, e.g. a playback device or a copy made by a non-compliant device.

Although the description refers to genre information, other user changeable information is also advantageously handled according to the invention. Such user changeable information is, amongst others, a specific disk name, title name, source name, station name, parental control information, reference to location or name of additional data like a thumbnail or still picture related to the recording or a summary.

1-7. (canceled)

8. Method for updating of content information related to an audio/visual storage medium wherein content information is being stored on the storage medium after generating the content information, and wherein the storage medium is recorded with a data stream of data element blocks consisting of header data and payload data, and containing user data areas, and the updated content information is stored in a user data area of the data stream stored on the storage medium.

9. Method according to claim 8 wherein the user data area of the data stream is one of
user data area of management information data stream, and
user data area of audio/video data stream, and
user data area of auxiliary data stream.

10. Method according to claim 9, wherein the content information stored in the user data area of the data stream is one of
content information related to the respective data stream partition, and
content information related to the respective storage medium, and
content information related to a plurality of storage media.

11. Method according to claim 10, wherein content information stored on the storage medium and content information present in a reading and/or recording device is compared every time the storage medium is inserted to or removed from the device and an update of the respective outdated information is performed, where possible.

12. Method according to claim 11, wherein the content information contains one or more of genre information, storage medium name, title name, and related data name.

13. Method according to claim 8, wherein the content information stored in the user data area of the data stream is one of
content information related to the respective data stream partition, and
content information related to the respective storage medium, and
content information related to a plurality of storage media.

14. Method according to claim 13, wherein content information stored on the storage medium and content information present in a reading and/or recording device is compared every time the storage medium is inserted to or removed from the device and an update of the respective outdated information is performed, where possible.

15. Method according to claim 14, wherein the content information contains one or more of genre information, storage medium name, title name, and related data name.

16. Method according to claim 8, wherein content information stored on the storage medium and content information present in a reading and/or recording device is compared every time the storage medium is inserted to or removed from the device and an update of the respective outdated information is performed, where possible.

17. Method according to claim 16, wherein the content information contains one or more of genre information, storage medium name, title name, and related data name.

18. Method according to claim 8, wherein the content information contains one or more of genre information, storage medium name, title name, and related data name.

19. Device for performing the method of claim 11.

20. Storage medium containing content information being stored in a user data area of the data stream recorded on the storage medium.

21. Storage medium according to claim 20 wherein the user data area of the data stream is one of
user data area of management information data stream, and
user data area of audio/video data stream, and
user data area of auxiliary data stream.

22. Storage medium according to claim 21, wherein the content information stored in the user data area of the data stream is one of
content information related to the respective data stream partition, and
content information related to the respective storage medium, and
content information related to a plurality of storage media.

23. Storage medium according to claim 22, wherein the content information contains one or more of genre information, storage medium name, title name, and related data name.

24. Storage medium according to claim 20, wherein the content information stored in the user data area of the data stream is one of
content information related to the respective data stream partition, and
content information related to the respective storage medium, and
content information related to a plurality of storage media.

25. Storage medium according to claim 24, wherein the content information contains one or more of genre information, storage medium name, title name, and related data name.

26. Storage medium according to claim 20, wherein the content information contains one or more of genre information, storage medium name, title name, and related data name.
